(19) United States
(12) Patent Application Publication
(10) Pub. No.: US 2022/0121549 A1
(43) Pub. Date: Apr. 21, 2022

(54) SYSTEMS AND METHODS FOR RENDERING UNIFIED AND REAL-TIME USER INTEREST PROFILES

(71) Applicant: Oath Inc., Dulles, VA (US)

(72) Inventors: Sanika SHIRWADKAR, Milpitas, CA (US); Kostas TSIOUTSIOULIKLIS, Saratoga, CA (US); Rao SHEN, Sunnyvale, CA (US)

(73) Assignee: Oath Inc.

(21) Appl. No.: 17/072,849

(22) Filed: Oct. 16, 2020

(51) Int. Cl. G06F 11/34; G06K 9/62

(52) U.S. Cl. CPC G06F 11/3438; G06K 9/6261; G06K 9/623

(57) ABSTRACT

The instant system and methods solves the cold start problem through various systems and methods directed to aggregating user interaction data associated with a user over a period of time, scoring the user interaction data to determine at least one user interest relevance score and/or at least one surfacing user interest score for each of the plurality of user interaction types, wherein the scoring includes a time sensitive weighting scheme, and generating a user interest profile partition for each of the plurality of user interaction types based on the at least one user interest relevance score and/or the at least one surfacing user interest score.

### TECHNICAL FIELD

The present disclosure relates to techniques for generating user interest profiles.

### BACKGROUND

Historically, one of the main interests of publishers is delivering relevant content to users at the right moment. Since each user may find different content relevant, attaining a deep understanding of the user's interests is crucial in order to deliver an engaging personalized consumer experience. For publishers with multiple properties, users typically interact with each property in various ways. These interactions may include browsing, reading, composing search queries via a search engine, online advertisements clicked by the user, emails opened, etc. Many of these interactions can be deeply informative about the user's interests and can be leveraged to enrich a publisher's current understanding of that user. However, publishers and publishing platforms often suffer from the cold start problem. The cold start problem surfaces when publishers do not have sufficient information about a new user's preferences in order to make content recommendations. One way to mitigate the cold start problem is to study the user's behavior at a property that the user frequently interacts with, and use the studied behavior to choose relevant content at a property that might be associated with the cold start problem. For example, if a user visits a publisher's news website for the first time, but is a regular visitor of the publisher's search engine website, the information learned from the user's search behavior can be effectively utilized to personalize the user experience on the news website.

Understanding user interests is a crucial component in powering next-generation data-driven consumer experiences. The following disclosure provides solutions to the aforementioned technological voids.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

Embodiments of the present disclosure include systems and methods for rendering unified and real-time user interest profiles.

According to certain embodiments, computer-implemented methods are disclosed for rendering unified and real-time user interest profiles. One method may include aggregating user interaction data associated with a user over a period of time, the user interaction data corresponding to a plurality of user interaction types, each of the plurality of user interaction types defining an interaction type and an interaction source; scoring, via a user activity module, the user interaction data to determine at least one user interest relevance score and/or at least one surfacing user interest score for each of the plurality of user interaction types, wherein the scoring includes a time sensitive weighting scheme; and generating a user interest profile partition for each of the plurality of user interaction types based on the at least one user interest relevance score and/or the at least one surfacing user interest score.

According to certain embodiments, systems are disclosed for rendering unified and real-time user interest profiles. One system may include a memory device that stores instructions; and at least one processor that executes the instructions and is configured for aggregating user interaction data associated with a user over a period of time, the user interaction data corresponding to a plurality of user interaction types, each of the plurality of user interaction types defining an interaction type and an interaction source; scoring, via a user activity module, the user interaction data to determine at least one user interest relevance score and/or at least one surfacing user interest score for each of the plurality of user interaction types, wherein the scoring includes a time sensitive weighting scheme; and generating a user interest profile partition for each of the plurality of user interaction types based on the at least one user interest relevance score and/or the at least one surfacing user interest score.

According to certain embodiments, non-transitory computer readable medium are disclosed for rendering unified and real-time user interest profiles. One non-transitory computer readable medium comprising a memory storage device storing and one or more processors configured to execute instructions for: aggregating user interaction data associated with a user over a period of time, the user interaction data corresponding to a plurality of user interaction types, each of the plurality of user interaction types defining an interaction type and an interaction source; scoring, via a user activity module, the user interaction data to determine at least one user interest relevance score and/or at least one surfacing user interest score for each of the plurality of user interaction types, wherein the scoring includes a time sensitive weighting scheme; and generating a user interest profile partition for each of the plurality of user interaction types based on the at least one user interest relevance score and/or the at least one surfacing user interest score.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram illustrating an example of a computer network and environment within which the computer systems and methods disclosed herein are implemented, according to some embodiments of the present disclosure.

FIG. 2 is a flow diagram illustrating steps of a method for rendering user interest profile partitions and unified user interest profiles, in accordance with some embodiments of the present disclosure.

FIG. 3 is a block diagram illustrating a generation scheme for rendering user interest profile partitions and unified user interest profiles, in accordance with some embodiments of the present disclosure.

FIG. 4 depicts a data flow diagram illustrating steps of a method for rendering user interest profile partitions and unified user interest profiles, in accordance with some embodiments of the present disclosure.

### DETAILED DESCRIPTION OF EMBODIMENTS

While principles of the present disclosure are described herein with reference to illustrative embodiments for particular applications, it should be understood that the disclosure is not limited thereto. Those having ordinary skill in the art and access to the teachings provided herein, will recognize that the features illustrated or described with respect to one embodiment, may be combined with the features of another embodiment. Therefore, additional modifications, applications, embodiments, and substitution of equivalents, all fall within the scope of the embodiments described herein. Various non-limiting embodiments of the present disclosure will now be described to provide an overall understanding of the principles of the structure, function, and use of systems and methods for rendering unified and real-time user interest profiles.

Two main approaches may be used to collect user interests: explicit and implicit. In the explicit approach, users explicitly declare their interests to the provider. This approach provides high-confidence data with little noise. However, explicit data is also sparse, as very few users are willing to explicitly declare their interests. Furthermore, explicit profiles tend to be static in nature, since very few users update their previously-declared interests.

Conversely, the implicit approach utilizes users' interactions with the system and dynamically deduces their interests. The focus of this disclosure is on the implicit approach. Moreover, some user profiling approaches use a statistical method to generate user profiles. One such approach is based on the Chi-Square test, where the user profiles are created based on the features that have a significantly higher value for that user compared to the average value of the population. Some of the currently-available systems utilize a similar approach, wherein user interest features are based on the user's property-specific user interaction behavior. However, although these features are useful for property-specific use cases, they provide limited insights into the users' overall preferences and are not generic enough to cater to all use cases. Furthermore, they lack the ability to handle the cold start problem. Additionally, the generated interests scores are usually not human interpretable, and therefore have limited applications.

Accordingly, the present disclosure is directed to systems and methods for aggregating and analyzing implicit user actions by rendering unified and real-time user interest profiles. In the implicit approach, the user profile is inferred from the features of the items that the user interacts with. The user interaction system disclosed herein is a part of an extensible user interest profile generation framework configured, in one embodiment, to at least implement a versatile user interests scoring algorithm in order to render unified and real-time user interest profile partitions and profiles. The user interest profile generation framework may implement the user interest profiling method based on the following formula: Pₜ=function (Pₜ₋₁, User behavior Δ(t−1, t)), wherein the formula determines the optimum interest profile Pₜ, at any given time t using the previous state of the interest profile (Pₜ₋₁), and the user interactions observed between time t−1 and t. The user interest profile generation framework may implement various instructions for building separate user interest profiles, called user interest profile partitions (P1ₜ, P2ₜ, P3ₜ, etc.), based on factors such as the source of the interactions, type of the user interaction, and time span of the interactions history. Examples of user interaction data sources include, but are not limited to, media content properties, search services, e-mail services, media streaming services, and digital storage drives. User interaction types can include, but are not limited to, article clicks, skips, video views, search queries and result selection, user comments, e-mail usage including open or delete actions, social media usage, virtual world or electronic gaming usage, downloaded data or content, streamed data or content, user application and device settings and preferences, etc. Examples of time span of interactions include building partitions based on the long-term interaction history (such as, e.g., interactions from the last few months or years) or building partitions based on the short term interaction history (such as, e.g., interactions from the previous seconds, minutes, hours, days, and weeks).

The generated individual profile partitions can then be consolidated into a unified user profile in such a way that it can be optimized for a given use case. The consolidated profile can be formulated as a function of the individual interest profile partitions as shown below. This function can be learned based on a specific target use case. For example, it can be learned as a linear function, wherein each interest profile partition is weighted depending on their importance for a given target use case:

Final Unified Profile (for Use Case-A):

Pₜ=w₁P1ₜ+w₂P2ₜ+ . . . +wₙPnₜ

where w₁ and w₂ are the weights assigned to the interest profile partitions P1ₜ and P2ₜ respectively. Since the weights can be optimized for a given use case, the proposed framework provides the ability to empower multiple use cases. Additionally, the proposed framework enables a plug-and-play architecture where specific user interest profile partitions can be included or excluded depending on their relevance to the given use case. For example, if a user's behavior (e.g. clicks) on Yahoo.com (i.e., Yahoo's Homepage) are tracked, and recent search queries and user notifications are logged in a database as the two most important features for the user, then the final profiles for a new use case for the user on a new digital property (e.g. a website) can be built using a weighted combination of these specific search preference and notification partitions. In another example, if a user streams several movies from the same genre through Verizon Fios, the final profile can be built using a weighted combination of the specific user movie genre preference partitions.

The present disclosure also proposes a user interest scoring algorithm that includes two different techniques of scoring the user interests: scoring for human interpretability and scoring for surfacing unique interests. The user interest profile generation framework then combines both of these scores in the format [user-interestsᵢ, s1ᵢ, s2ᵢ], where s1 and s2 represent the scores generated by the above two techniques, respectively. Both scoring techniques use features based on the frequency, recency and temporality of the user interactions, and also on the relevance of the interests in these interactions. The user interest scoring algorithm uses a time sensitive weighting scheme to account for the users' evolving interests. Additionally, the scores accumulate over time. This, along with the time-sensitive weighting scheme, is leveraged to surface (i.e., identify) the users' long-term interests as well as their most recent interests.

The scoring technique for human interpretability generates a user profile with scores that reflect, move in sync, and fluctuate based on user activity. For example, the more a user interacts with an interest (e.g. search queries on a particular sporting event), the higher its score. The interest scores vary depending on the frequency of the user interactions with that interest. These scores are “human interpretable” in the sense that the interests it surfaces, given the users' interactions, intuitively make sense to humans. This scoring technique can be effectively utilized for various use cases where identification of users' top interests, regardless of the popularity or uniqueness of the interests, is required. For example, use cases such as user interest dashboards, user notifications, or personalized modules (i.e. cards) can benefit from this scoring technique. Specifically, each user interest profile partition P(n)ₜ is defined as follows:

P(n)ₜ=(λ(n)*P(n)ₜ₋₁)+S(n)_{Δ(t-1,t)}

where λ is the temporal decay factor denoting the decay rate of the user's interests over time and P(n)ₜ₋₁ is the previous profile state. At a given time t, the current state of the interest profile partition gets incrementally updated by applying a decay to the previous interest profile partition state Pₜ₋₁ and by adding new scores based on the recent interactions between time interval t−1 and t. For a given user interaction, each associated interest-i is assigned an initial score based on the relevance of that interest in that interaction. Notably, the interest and relevance scores may be pre-tagged by, for example, a remote or third party system. S(n)_{Δ(t-1,t)} represents the normalized summation vector of these interest relevance scores in the space of partition n. The interest scores themselves signify the inferred relative importance of that interest to the user, given the recent interactions in the timeframe between t−1 and t, whereas P(n)ₜ₋₁ scores represent the inferred historical importance of the interest to the user.

The scoring technique for surfacing unique interests aims to promote unique interests over popular interests and is particularly effective for generating user interest profile partitions related to the media stream ranking use case. This scoring technique may complement the existing content popularity-based technique. However, as the technique for surfacing unique interests promotes unique interests over popular interests, it does not score the interests uniformly. The generated scores are therefore not human-intuitive (i.e., not human-interpretable), thus giving rise to the need for the human interpretable scoring discussed above. In the scoring technique for surfacing unique interests, each user interest profile partition P(n)ₜ is defined as follows:

P(n)ₜ=(λ(n)*P(n)ₜ₋₁)+(S(n)_{Δ(t-1,t)}*IUIIF(n)_{Δ(t-1,t)})

where the definitions of P(n), λ(n) and S(n) are the same as discussed above in reference to the scoring technique for human interpretability. IUIIF(n)_{Δ(t-1,t)} represents the inverse user interest interaction frequency (IUIIF), which is defined as follows:

IUIIF(n,interest-i)_{Δ(t-1,t)}=(count(partition-n users)/count(partition-n users who have interacted with interest-i between time t−1 and t)).

IUIIF scores denote how rare or meaningful an interest is, given all user interactions in a partition. These scores are generated for every interest, and are unique to each partition. The values are log normalized.

TABLE 1
IUIIF Scoring By-product: Surfacing Current Most Interacted
Interests Per Property.

| PROPERTY | INTEREST-1 | INTEREST-2 | INTEREST-3 |
|---|---|---|---|
| HOMEPAGE | DONALD TRUMP | WHITE | COVID-19 |
| | | HOUSE | PANDEMIC |
| SPORTS | NATIONAL | LEBRON | COLIN |
| | BASKETBALL | JAMES | KAEPERNICK |
| | ASSOCIATION | | |
| FINANCE | STOCK MARKET | WARREN | S&P 500 INDEX |
| | | BUFFET | |

Since the IUIIF scoring scheme assigns lowest scores to the most interacted interests, as it can be seen from Table 1 above, an interesting by-product of this scoring is identification of the most interacted interests per partition. These attributes can potentially serve as a useful feature in use cases that can benefit from utilizing the current most interacted interests.

With both scoring techniques (i.e., the scoring technique for human interpretability and the scoring technique for surfacing unique interests), the interests can be decayed over time by applying a global decay or a local decay. In the global decay approach, the same decay rate can be applied to all interests in all user interest profile partitions. Whereas, in the local decay approach, a separate optimized decay rate can be applied to each user interest profile partition. This approach can also be extended further to apply a separate decay rate for each interest type (e.g., long-term interests may decay at a different rate than recent or seasonal interests), or a separate decay rate for each interest (e.g., a decay based on time elapsed between a current time and a time of most recent interaction with the interest).

The previous profile state P(n)ₜ₋₁ can either span a short time period of user interactions or a long period of historical user interactions. By controlling when the first instance of the previous state P(n)ₜ₋₁ is generated, the proposed user interest scoring algorithm can be efficiently utilized to construct long-term profiles (e.g., profiles based on interactions from the last few months) or short-term profiles (e.g., profiles based on interactions from the most recent day or week). The following Table 2 includes exemplary long-term user interest profile partitions that may be implemented using the proposed user interest scoring algorithm.

TABLE 2
Long-Term Interest Profile Partitions Implemented for
Production Traffic.

| SOURCE OF | |
|---|---|
| INTERACTIONS | USER INTERACTION TYPE |
| HOMEPAGE | CONTENT PAGE VIEWS, YAHOO HOMEPAGE |
| | STREAM SKIPS |
| SPORTS | YAHOO SPORTS PAGE VIEW, SPORTS TEAM OR |
| | PLAYER PAGE VISITED, YAHOO SPORTS |
| | STREAM SKIPS |
| FINANCE | YAHOO FINANCE PAGE VIEW, FINANCE TICKER |
| | PAGE VISITED, YAHOO FINANCE STREAM SKIPS |
| SEARCH | SEARCH QUERIES, SEARCH PAGE CLICKS |
| ADS | AD CLICKS, AD CONVERSIONS |
| MAIL | COMMERCIAL EMAILS OPENED, |
| | COMMERCIAL EMAILS DELETED |

The current user profile P(n)ₜ can be updated incrementally. These updates can be performed either on a monthly, weekly, and daily basis or in real time. By updating P(n)ₜ after every user interaction, the proposed user interest scoring algorithm can be effectively applied to build real-time profiles and therefore can be leveraged to render real-time personalization on a given property.

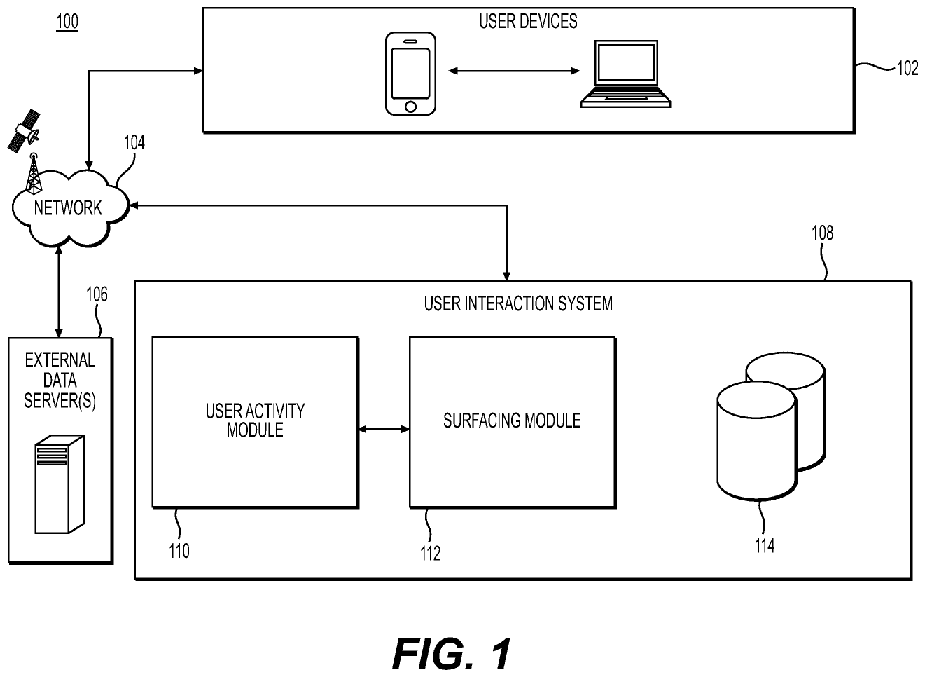

FIG. 1 is a schematic diagram illustrating an example of a computer network and environment within which the computer systems and methods disclosed herein are implemented, according to some embodiments of the present disclosure. As shown in FIG. 1, user interaction environment 100 may include a plurality of personal computing devices 102, external data sever(s) 106, a user interaction system 108, all in communication with one another via a network 104, such as the Internet.

The personal computing devices 102 may include virtually any desktop or portable computing devices capable of sending and receiving data over a network, such as network 104, or the like. For example, a personal computing device 102 may be a mobile phone, a tablet device, a connected Internet-of-Things device (e.g., connected appliance or connected vehicle), a desktop computer, a laptop computer, a landline phone, a gaming system, a television, smart accessory, and/or a digital or artificial intelligence-enabled virtual personal assistant. Personal computing devices 102 may include virtually any portable computing device capable of connecting to another computing device and receiving information, as discussed above. Personal computing devices 102 may also be configured to execute at least one native or web-based client application (e.g., a communication application) that is configured to receive communication and/or content from another computing device. In some embodiments, a virtual assistant (e.g., Alexa®, Portal®, or Home®) may also communicate with a server, a mobile device, or other virtual assistants (e.g., a smart speaker or smart home hub), or the like. In one embodiment, such communications may include sending and/or receiving messages or voice/video calls, searching for, viewing, and/or sharing photographs, digital images, audio clips, video clips, or any of a variety of other forms of communications. Personal computing devices 102 may be configured for sending or receiving signals, such as via a wired or wireless network, or may be configured for processing or storing signals, such as in memory as physical memory states, and may, therefore, operate as a server. Network 104 may be configured to couple personal computing devices 102 and their components with components corresponding to the user interaction system 108. It should be appreciated that any devices or servers of FIG. 1 may be configured to communicate with each other directly, such as through Bluetooth or any other near-field communication (NFC) protocol. Network 104 may include any of a variety of wireless sub-networks that may further overlay stand-alone ad-hoc networks, and the like, to provide an infrastructure-oriented connection for the personal computing devices 102.

In general, network 104 may include local area networks (“LANs”), wide area networks (“WANs”), wireless network, or any combination thereof, and may be configured to implement protocols for transmitting data to and from computing devices accessing the user interaction system 108. Not all the components featured in FIG. 1 may be required to practice the disclosure, and variations in the arrangement and type of the components may be made without departing from the spirit or scope of the disclosure.

The external data server(s) 106 may include one or more of personal computers desktop computers, multiprocessor systems, microprocessor-based or programmable consumer electronics, database(s), network PCs, server(s), and the like, maintained by third parties storing business-to-business or business-to-consumer data (e.g. Verizon®, Microsoft®, Google®, Kayak®, Facebook®, Amazon®, a government entity, or the like). The user interaction system 108 may receive data stored on the external data server(s) 106 on one or more of its computing devices. The data stored at the external data server(s) 106 may include, but is not limited to, user interaction information related to emails, search queries, search result selections, web browsing, instant messaging messages, social media messages, media content, digital endorsement content, news content, virtual world messages (e.g., video game or virtual reality messaging), order details (e.g., cost of each item purchased, total cost of purchase, expected shipping or arrival date of each product, order number, product details, etc.), rewards information, weather, news, shipping details (e.g., expected date/time of arrival of a package, tracking number, carrier information, etc.), transportation (e.g., public and private data related to airplanes, rocket ships, trains, and aquatic vehicles), mobile devices (e.g., iPhone®), smart accessories (e.g., Apple Watch®), artificial intelligence-enabled devices (e.g. Alexa®, Google Home®, Facebook Portal®, and the like), and GPS data corresponding to a user or a personal computing device 102. For example, the user interaction system 108 may receive or may be able to parse data from the external data server(s) 106 pertaining to specific user(s)/member(s)/user group(s) and their use of electronic messaging applications (e.g., email) in order to identify specific interactions (e.g., created, open, closed, deleted, email message) the users carried out while using the electronic messaging applications.

As shown in FIG. 1, user interaction system 108 may include a user activity module 110, a surfacing module 112, database 114 (one or more databases), and one or more processors, network interface(s), and user interface(s). In addition, user interaction system 108 may be configured to execute one or more user activity scoring algorithms via software modules 110-112 based on instructions and data stored in a database 114. The databases may be any type of database or memory, and may be configured to be in direct communication with the user interaction system 108.

User activity module 110 may include one or more devices and/or executable codes for extracting data related to user actions and rendering a user profile based on a human interpretability scoring algorithm. Devices that may operate as a user activity module 110 may include one or more of personal computers, desktop computers, multiprocessor systems, microprocessor-based or programmable consumer electronics, network PCs, server(s), and the like. User activity module 110 may further facilitate user access to and provide information in an auditory or visual manner for a variety of services that include, but are not limited to, e-mail services, media services, content streaming services, storage services, alert/notification(s), instant messaging (IM) services, streaming and/or downloading media services, search services, photo services, web services, social networking services, news services, third-party services, audio services, video services, SMS services, MMS services, FTP services, telephony services, voice over IP (VOIP) services, gaming services, or the like. The user activity module 110 may be configured to automatically extract data pertaining to a type of user interaction (e.g., perform search query), source of the user interaction (e.g., search engine), time span (e.g., week) of the interactions history received or stored in a database corresponding to the user interaction system 108, external data server(s) 106, and/or information received from the personal computing devices 102.

The user activity module 110 may be configured to implement one or more algorithms in order to determine a user's optimum interest profile at any given point in time. For example, the user activity module 110 may render user interest profile partitions based on the following formula: Pₜ=function (Pₜ₋₁, User behavior Δ(t−1, t)). User interaction types analyzed by the user activity module 110 can include, for example, media downloads, user interface preferences, article clicks or skips, video views, search queries, user comments, e-mail open or delete actions, or electronic message actions. Examples of user interaction data sources include one or more of electronic media properties, search services, email services, etc. Examples of time span of interactions include building partitions based on the long-term interaction history (such as, e.g., interactions from the last few months) or building partitions based on the short term interaction history (such as, e.g., interactions from the previous 1 week). The generated individual interest profile partitions can then be consolidated into a unified user profile in such a way that it can be optimized for a given use case where a user is interacting with a new source and there is no known user interaction data corresponding to the user as it relates to the new source stored at the user interaction system 108 or at an external data server(s) 106. Once the one or more user interest profile partitions are generated, each of the one or more partitions may be scored for human interpretability via the following formula: P(n)ₜ=(λ(n)*P(n)ₜ₋₁)+S(n)_{Δ(t-1,t)}, in order to determine interest relevance scores in the space of the partition being processed.

Surfacing module 112 may include one or more devices and/or executable codes for identifying unique user interests from a pool of potentially popular interests. Devices that may operate as a surfacing module 112 may include one or more of personal computers, desktop computers, multiprocessor systems, microprocessor-based or programmable consumer electronics, network PCs, server(s), and the like. Specifically, surfacing module 112 may be configured to automatically extract data pertaining to a type of user interaction (e.g., request for media), source of the user interaction (e.g., media streaming application), time span (e.g., month) of the interactions history received or stored in a database corresponding to the user interaction system 108, external data server(s) 106, and/or information received from the personal computing devices 102. The surfacing module 112 may be configured to implement one or more algorithms in order to determine a user's unique interests over popular interests. For example, the surfacing module 112 may analyze the user interest profile partitions rendered by the user activity module 110, and derive uniqueness scores for various interests (i.e., surfacing user interest scores) in each of the partitions via the following formula: P(n)ₜ=(λ(n)*P(n)ₜ₋₁)+(S(n)_{Δ(t-1,t)}*IUIIF(n)_{Δ(t-1,t)}). User interaction types analyzed by the surfacing module 112 can include, for example, media downloads, user interface preferences, article clicks or skips, video views, search queries, user comments, e-mail open or delete actions, or electronic message actions. Examples of user interaction data sources include one or more electronic media properties, search services, email services, etc. Examples of time span of interactions include building partitions based on the long-term interaction history (such as, e.g., interactions from the last few months) or building partitions based on the short term interaction history (such as, e.g., interactions from the previous 1 week). The generated individual profile partitions can then be consolidated into a unified user profile in such a way that it can be optimized for a given use case where a user is interacting with a new source and there is no known user interaction data corresponding to the user as it relates to the new source stored at the user interaction system 108 or at an external data server(s) 106.

Database 114, may be comprised of one or more databases, for example, a distribution database, a relational database, an object-oriented database, a cloud database or a centralized database. Database 114 may store instructions for processing partitions, user interaction data, and content. Database 114 may be in direct communication with personal computing devices 102 and external data servers 106.

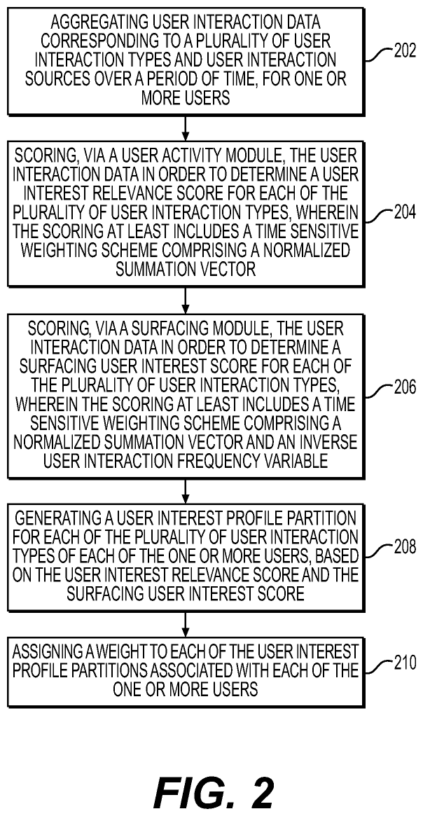

FIG. 2 depicts a flow diagram illustrating steps of a method for rendering user interest profile partitions and unified user interest profiles, in accordance with some embodiments of the present disclosure. As shown in FIG. 2, in one embodiment, user interaction system 108 may be configured for generating a user interest profile partition by aggregating user interaction data corresponding to a plurality of user interaction types and user interaction sources over a period of time, for one or more users (Step 202). Each of the plurality of user interaction types may define an interaction type and an interaction source. For example, the user interaction system 108 may render one or more profile partitions for a user, based on the user's interaction data (e.g., clicks, queries, content requests) at one or more electronic properties (e.g., media streaming content application, storage service, search service, or email service). The user interaction system 108 may then implement instructions for scoring, via a user activity module 110, the user interaction data in order to determine a user interest relevance score for each of the plurality of user interaction types (e.g., content requests), wherein the scoring at least includes a time sensitive weighting scheme comprising a normalized summation vector (e.g., P(n)ₜ=(λ(n)*P(n)ₜ₋₁)+S(n)_{Δ(t-1,t)}) (Step 204). For example, once the user's profile partitions are rendered, the user interaction system 108 may apply a user interest scoring technique to the data associated with the user profile partition(s). The user interaction system 108 may then implement instructions for scoring, via a surfacing module 112, the user interaction data in order to determine a surfacing user interest score for each of the plurality of user interaction types (e.g., content requests), wherein the scoring at least includes a time sensitive weighting scheme comprising a normalized summation vector and an inverse user interaction frequency variable (e.g., P(n)ₜ=(λ(n)*P(n)ₜ₋₁)+(S(n)_{Δ(t-1,t)}*IUIIF(n)_{Δ(t-1,t)})) (Step 206). Here, for example, the user interaction system 108 may implement a scoring technique that, once applied to the profile partition data, identifies unique user interests amongst a plurality of popular interests.

The user interaction system 108 may then implement instructions for generating a user interest profile partition for each of the plurality of user interaction types of each of the one or more users, based on the user interest relevance score and/or the surfacing user interest score (Step 208). For example, the user interaction system 108 may render individual partitions for each user interaction type (e.g. click query), each user interaction source (e.g. search engine or media streaming application), and at or over a specific point of time (e.g. week or month). It should be noted that the user interest profile partition may be generated based on one of the user interest relevance score and the surfacing user interest score. Therefore, just one of Step 204 and Step 206 may be performed. In some embodiments however, both Step 204 and Step 206 may be performed, and both user interest relevance score and surfacing user interest score may be used to generate the user interest profile partition. The user interaction system 108 may then implement instructions for assigning a weight to each of the user interest profile partitions associated with each of the one or more users (Step 210). For example, the user interaction system 108 may generate a user profile by assigning weights to each profile partition based on the rendered partitions, and based on the relevance of the partition to the specific source and features available to users at the source being evaluated.

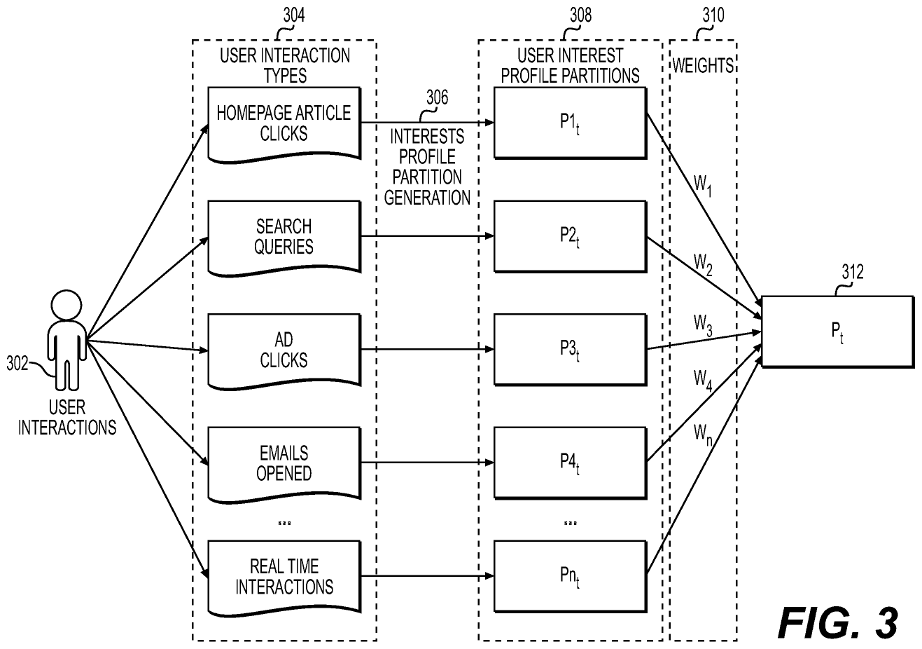

FIG. 3 is a block diagram illustrating a scheme for rendering user interest profile partitions and unified user interest profiles, in accordance with some embodiments of the present disclosure. The user interaction system 108 may be configured for generating a unified user interest profile by aggregating and processing user interaction data 302 corresponding to a plurality of user interaction types 304 at various user interaction sources over a period of time, for one or more users. The user interest profile generation framework may generate the user interest profile partitions 308 via the following formula: Pₜ=function (Pₜ₋₁, User behavior Δ(t−1, t)), which determines the optimum interest profile Pₜ, at any given time t using the previous state of the interest profile (Pₜ₋₁), and the user interactions observed between time t−1 and t. The partitions 308 may be generated based on factors such as the source of the interactions, the type of the user interactions, and the time span of the interactions history. Examples of user interaction data sources include, but are not limited to, media content properties, e-mail properties, media streaming services, and digital storage drives. User interaction types can include, but are not limited to, article clicks, skips, video views, search queries and result selections, user comments, e-mail usage including e-mail open or delete actions, search engine queries and results, social media usage, virtual world or electronic gaming usage, downloaded data or content, streamed data or content, and user application and device settings and preferences, etc. Examples of the time span of interactions include building partitions based on the long term interaction history (such as, e.g., interactions from the last few months or years) or building partitions based on the short term interaction history (such as, e.g., interactions from the previous seconds, minutes, hours, days, and weeks).

The generated user interest profile partitions 308 can then be consolidated into a unified user profile in such a way that it can be optimized for a given use case. The consolidated profile 312 can be formulated as a function of the individual interest partitions, as shown below. This function can be learned based on a specific target use case. For example, it can be learned as a linear function, wherein each user interest profile partition 308 is weighted using the weights 310 depending on the importance and relevance of each partition for a given target use case (e.g., a new digital property the user has never interacted with before):

Final Unified Profile (for Use Case-A):

Pₜ=w₁P1ₜ+w₂P2ₜ+ . . . +wₙPnₜ

where w₁, w₂, . . . wₙ are the weights 310 assigned to the interest profile partitions 308 P1ₜ, P2ₜ, . . . , Pnₜ respectively. The weights can be optimized for a given use case, this framework provides the ability to empower multiple use cases. Additionally, the proposed user interest profiling framework enables a plug-and-play architecture where specific user interest partitions can be included or excluded depending on their relevance to the given use case. For example, if a user's behavior (e.g. clicks) on Yahoo.com (i.e., Yahoo's Homepage) are tracked, and recent search queries and user notifications are logged in a database as the two most important features for the user, then the final profiles for a new use case for the user on a new digital property (e.g. a website) can be built using a weighted combination of these specific search preference and notification partitions. In another example, if a user streams several movies from the same genre through Verizon Fios, the final profile can be built using a weighted combination of the specific user movie genre preference partitions. The present disclosure also proposes a user interest scoring algorithm that includes two different techniques of scoring the user interests: scoring for human interpretability and scoring for surfacing unique interests. The user interest profile generation framework then combines both of these scores in the format [user-interests s1ᵢ, s2ᵢ], where s1 and s2 represent the scores generated by the above two techniques, respectively. Both scoring techniques use features based on the frequency, recency and temporality of the user interactions, and also on the relevance of the interests in these interactions. The user interest scoring algorithm uses a time sensitive weighting scheme to account for the users' evolving interests. Additionally, the scores accumulate over time. This, along with the time sensitive weighting scheme, is leveraged to surface (i.e. identify) the users' long-term interests as well as their most recent interests.

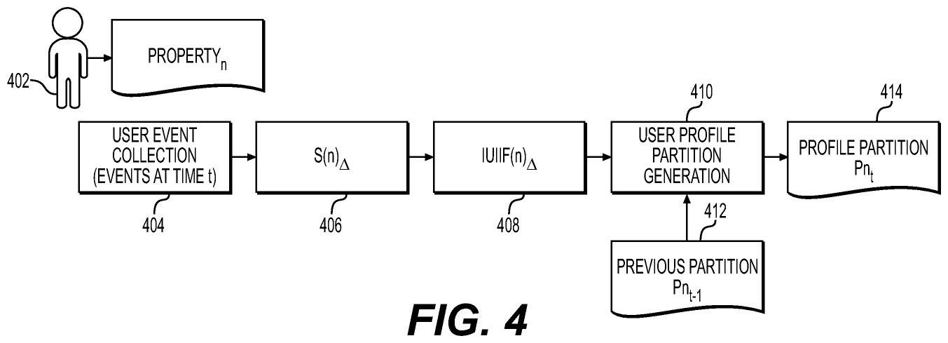

FIG. 4 depicts a data flow diagram illustrating steps of a method for rendering user interest profile partitions and unified user interest profiles, in accordance with some embodiments of the present disclosure. As an initial step, for every property 402 (e.g. webpage, media application, e-mail service), relevant user interactions 404 at time t are collected. User interests associated with these interactions 404 and relevance scores of these interests may be pre-tagged by the user interaction system 108 or by a separate system, and therefore fetched. For each user and each partition, both a user interest score 406 and surfacing user interest score 408 are generated. Additionally, for each user, one or more user interest profile partitions 410 are generated, wherein each user interest profile partition is constructed using the previous user interest profile partition 412 at time t−1 (if available), current user interest scores and current surfacing user interest scores. As explained in FIG. 3, a unified user profile 414 at time t can then be generated using a weighted combination of these user interest profile partitions 140.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine-readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure, the term “server” should be understood to refer to a service point that provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software, for example virtual servers, and one or more database systems and application software that support the services provided by the server. Cloud servers are examples.

For the purposes of this disclosure, a “network” should be understood to refer to a network that may couple devices so that communications may be exchanged, such as between a server and a personal computing device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof Likewise, sub-networks, which may employ differing architectures or may be compliant or compatible with differing protocols, may intemperate within a larger network.

For purposes of this disclosure, a “wireless network” should be understood to couple personal computing devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4th or 5th generation (2G, 3G, 4G or 5G) cellular technology, Bluetooth, 802.IIb/g/n, or the like. Network access technologies may enable wide area coverage for devices, such as personal computing devices with varying degrees of mobility, for example.

In short, a wireless network may include any type of wireless communication mechanism by which signals may be communicated between devices, such as a personal computing device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a personal computing device may include a computing device capable of sending or receiving signals, such as via a wired or a wireless network. A personal computing device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A personal computing device may vary in terms of capabilities or features. Claimed subject matter is intended to cover a wide range of potential variations, such as a web-enabled personal computing device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display and components for displaying augmented reality objects, for example.

A personal computing device may include or may execute a variety of possible applications, such as a client software application enabling communication with other devices. A personal computing device may also include or execute an application to communicate content, such as, for example, textual content, multimedia content, or the like. A personal computing device may also include or execute an application to perform a variety of possible tasks, such as: browsing, searching, connecting to a network (e.g. the internet), receiving communications (e.g. phone call, emails, text messages, social media communications), streaming or displaying various forms of content, including locally stored or uploaded images and/or video, or games (such as live video calls).

Thus, while there has been described what are believed to be the preferred embodiments, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for profile partition generation comprising:
aggregating user interaction data associated with a user over a period of time, the user interaction data corresponding to a plurality of user interaction types, each of the plurality of user interaction types defining an interaction type and an interaction source;
scoring, via a user activity module, the user interaction data to determine at least one user interest relevance score and/or at least one surfacing user interest score for each of the plurality of user interaction types, wherein the scoring includes a time sensitive weighting scheme; and
generating a user interest profile partition for each of the plurality of user interaction types based on the at least one user interest relevance score and/or the at least one surfacing user interest score.

2. The computer-implemented method of claim 1, further comprising:
generating a unified user profile for the user, using a weighted combination of the generated user interest profile partitions.

3. The computer-implemented method of claim 1, wherein:
scoring the user interaction data to determine the at least one user interest relevance score includes the time sensitive weighting scheme comprising a normalized summation vector, and
scoring the user interaction data to determine the at least one surfacing user interest score includes the time sensitive weighting scheme comprising a normalized summation vector and an inverse user interaction frequency variable.

4. The computer-implemented method of claim 1, wherein the time sensitive weighting scheme decays user interest data by applying a decay rate to each user interest type.

5. The computer-implemented method of claim 1, wherein the interaction type includes: media streaming, search query, menu navigation, electronic messaging, or user application preference setting.

6. The computer-implemented method of claim 2, wherein the inverse user interaction frequency variable assigns a lowest score to a user interest type that the user interacted most frequently with.

7. The computer-implemented method of claim 1, further comprising generating one or more of: a user recommendation, a user notification, and a user profile customization based on the generated user interest profile partitions.

8. A system for profile partition generation comprising:
at least one processor; and
a storage device that stores a set of instructions, the set of instructions being executable by the at least one processor to cause the at least one processor to implement the steps of:
aggregating user interaction data associated with a user over a period of time, the user interaction data corresponding to a plurality of user interaction types, each of the plurality of user interaction types defining an interaction type and an interaction source;
scoring, via a user activity module, the user interaction data to determine at least one user interest relevance score and/or at least one surfacing user interest score for each of the plurality of user interaction types, wherein the scoring includes a time sensitive weighting scheme; and
generating a user interest profile partition for each of the plurality of user interaction types based on the at least one user interest relevance score and/or the at least one surfacing user interest score.

9. The system of claim 8, further comprising:
generating a unified user profile for the user, using a weighted combination of the generated user interest profile partitions.

10. The system of claim 9, further comprising:
scoring the user interaction data to determine the at least one user interest relevance score includes the time sensitive weighting scheme comprising a normalized summation vector, and
scoring the user interaction data to determine the at least one surfacing user interest score includes the time sensitive weighting scheme comprising a normalized summation vector and an inverse user interaction frequency variable.

11. The system of claim 8, wherein the time sensitive weighting scheme decays user interest data by applying a decay rate to each user interest type.

12. The system of claim 8, wherein the interaction type includes: media streaming, search query, menu navigation, electronic messaging, or user application preference setting.

13. The system of claim 9, wherein the inverse user interaction frequency variable assigns a lowest score to a user interest type that the user interacted most frequently with.

14. The system of claim 9, further comprising generating one or more of: a user recommendation, a user notification, and a user profile customization based on the generated user interest profile partitions.

15. A non-transitory computer readable medium storing instructions which, when executed by one or more processors, cause the one or more processors to perform operations for profile partition generation, the operations comprising:
aggregating user interaction data associated with a user over a period of time, the user interaction data corresponding to a plurality of user interaction types, each of the plurality of user interaction types defining an interaction type and an interaction source;
scoring, via a user activity module, the user interaction data to determine at least one user interest relevance score and/or at least one surfacing user interest score for each of the plurality of user interaction types, wherein the scoring includes a time sensitive weighting scheme; and
generating a user interest profile partition for each of the plurality of user interaction types based on the at least one user interest relevance score and/or the at least one surfacing user interest score.

16. The non-transitory computer readable medium of claim 15, further comprising:
generating a unified user profile for the user, using a weighted combination of the generated user interest profile partitions.

17. The non-transitory computer readable medium of claim 16, further comprising:
scoring the user interaction data to determine the at least one user interest relevance score includes the time sensitive weighting scheme comprising a normalized summation vector, and
scoring the user interaction data to determine the at least one surfacing user interest score includes the time sensitive weighting scheme comprising a normalized summation vector and an inverse user interaction frequency variable.

18. The non-transitory computer readable medium of claim 15, wherein the time sensitive weighting scheme decays user interest data by applying a decay rate to each user interest type.

19. The non-transitory computer readable medium of claim 15, wherein the interaction type includes: media streaming, search query, menu navigation, electronic messaging, or user application preference setting.

20. The non-transitory computer readable medium of claim 15, wherein the inverse user interaction frequency variable assigns a lowest score to a user interest type that the user interacted most frequently with.
